(19) United States
(12) Patent Application Publication
(10) Pub. No.: US 2011/0005790 A1
(43) Pub. Date: Jan. 13, 2011

(54) HAND GRIP

(76) Inventors: Mario Frank, Solothurn (CH); Ulrich Mueller-Boysen, Esslingen (DE); Joachim Schadow, Stuttgart (DE); Roswitha Eicher, Filderstadt (DE); Stefan Heess, Leinfelden-Echterdingen (DE); Joerg Maute, Sindelfingen (DE); Juergen Wiker, Zhejiang (CN); Siegfried Keusch, Deizisau (DE); Florian Fsenwein, Uhingen-Holzhausen (DE); Bernhard Eicher, Filderstadt (DE); Marcus Schuller, Dettenhausen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/528,600

(22) PCT Filed: Jan. 8, 2008
(86) PCT No.: PCT/EP08/50142

§ 371 Date: Aug. 25, 2009

(30) Foreign Application Priority Data
Feb. 26, 2007 (DE) 10 2007 009 169.0

(51) Int. Cl. B25D 17/04; B25G 1/10

(52) U.S. Cl. 173/162.2; 16/421

(57) ABSTRACT

The invention relates to a hand grip having a grip core and a grip cover disposed on the grip core. The grip cover has at least one vibration-damping element. A fastening element is attached to the grip core. The vibration-damping means can be prestressed.

### PRIOR ART

The invention relates to a hand grip, in particular an auxiliary hand grip, for a hand-held power tool, as recited in the preamble to claim 1.

Numerous power tools such as angle grinders, drills, and rotary hammers are equipped with an auxiliary hand grip. In order to prevent vibrations that are produced during operation of the power tool from being transmitted to the user via the auxiliary hand grip, auxiliary hand grips are usually provided with vibration-damping means.

EP 0 490 850 A1, for example, has disclosed a vibration-damping hand grip for a power tool, which, in addition to a vibration-damping leaf spring between the grip region and the fastening element, also has a grip casing made of rubber as well as a damper mass in order to absorb vibrations.

in addition, DE 299 04 043 U1 has disclosed a grip casing that is composed of a plurality of stacked layers of polyurethane foams with different cell structures.

### DISCLOSURE OF THE INVENTION

The hand grip according to the invention is based on a hand grip that has a grip core, a grip casing supported on the grip core, and a fastening element. The grip casing is embodied in a vibration-damping fashion in that it has one or more vibration-damping means, which are prestressable according to the invention. In the context of the present invention, “prestressable vibration-damping means” are understood to be vibration-damping means whose prestressing is embodied as adjustable. The intensity of the prestressing determines how powerful a vibration-damping action is exerted by the vibration-damping means. It is thus possible to adjust the damping properties of the vibration-damping grip casing either to each user of the hand-held power tool or to each specific application. If the grip casing is to exert a more powerful vibration-damping action, then the prestressing is reduced. Conversely, if the grip case is to exert a less powerful vibration-damping action, then the prestressing can be increased. Consequently, the hand grip according to the invention can be used in a versatile fashion for a wide variety of applications and a wide variety of users.

In particular, the at least one vibration-damping means is prestressable because a prestressing element is provided for adjusting the prestressing. The prestressing element can be mounted onto the grip core by means of a thread, for example. It is thus possible to increase or decrease the prestressing of the vibration-damping grip casing by means of a screwing motion of the prestressing element on the grip core.

In addition, the prestressing element can be embodied in the form of a damper element that allows the prestressing element to produce an additional vibration-damping action. Preferably, the prestressing element in such an embodiment is composed of a metal.

Furthermore, the grip core can additionally or alternatively be embodied in the form of a damper mass, once again producing an additional vibration-damping action.

The grip core is preferably embodied in the form of a rod or the like that is situated in the grip casing, particularly in a coaxial orientation. It can be composed of metal and be embodied as solid. The grip core can, however, also be embodied in the form of a hollow cylinder that can, for example, accommodate additional vibration-damping means such as a damper mass. A metallic, rod-shaped grip core can also be extrusion-coated with a thermoplastic that gives the hand grip its shape and, for example, forms a collar-like expansion at the end of the hand grip oriented toward the housing of a hand-held power tool.

Preferably, the grip core extends through the entire hand grip in the axial direction. At the first end of the grip core, which, when being used on a hand-held power tool, is oriented toward the housing of the hand-held power tool, a fastening element is provided with which the hand grip can be fastened to the housing. In this case, the grip core can be embodied of one piece with the fastening element. For example, the grip core can be embodied so that it is provided with a thread, for example, at a freely protruding end. The hand grip can be screwed into the housing of the hand-held power tool with the aid of the thread. The fastening element, however, can also be a clamping device that can be clamped to a collar of a housing of a hand-held power tool.

In an alternative embodiment, though, the grip core and the fastening element can also be embodied as separate parts. In a simple embodiment, the fastening element can be a threaded bolt, for example, that is mounted onto the grip core or is accommodated in the grip core and its threaded part protrudes out from the grip core. In a similar fashion, a clamping device can also be embodied in the form of a separate piece situated on the grip core.

In another alternative embodiment, the fastening element can be embodied in the form of a receiving sleeve equipped with a nut. The receiving sleeve is provided to receive a screw that can be attached to the nut. In this case, a screw can be mounted onto the housing of the hand-held power tool. In order to attach the hand grip to the hand-held power tool, the screw is introduced into the receiving sleeve and screw-connected to the nut. The screw can be attached to the housing, for example, by means of a clamping device.

A second end of the grip core is preferably situated at the end of the hand grip oriented away from the housing of a hand-held power tool. The second end of the grip core is preferably provided with a prestressing element.

Various embodiments of vibration-damping means can be used to lend the grip casing vibration-damping properties. The vibration-damping grip casing can, for example, be composed of an elastic material, in particular an elastomer material such as rubber. It can, however, also be composed of a vibration-damping foam.

In another embodiment, the vibration-damping means can also be a net, a knitted fabric, a crocheted fabric, a meshwork, a weave, or the like, in particular composed of metal. In this case, the net, knitted fabric, crocheted fabric, or the like can be coated or covered with an elastomer material.

Alternatively the vibration-damping means can be a fluid-filled cushion. Suitable fluids include a gas such as air, a liquid such as water or oil, or a gel. The grip casing can be composed of a single damper cushion. The damper cushion, however, can also be subdivided into several chambers that are filled either with the same fluid or with different fluids. In this case, the chambers can, for example, be embodied in the form of conduits extending in the axial direction or in the form of honeycomb structures.

In the case of a fluid-filled damper cushion, the vibration-damping action can also be adjusted via the pressure of the fluid in the damper cushion. To that end, the damper cushion can be provided with a valve, for example.

The vibration-damping means constituting the grip casing can be situated around the grip core not only in a single layer, but also in a plurality of layers. For example, a plurality of layers composed of various elastomer materials, foams, damper cushions, etc. with different vibration-damping properties can be mounted onto the grip core. In this case, the vibration-damping means can be situated in a plurality of layers in the radial direction of the grip casing. The vibration-damping means can, however, also be situated in a plurality of layers in the axial direction of the grip casing so that a plurality of disk-shaped vibration-damping means are situated resting against one another axially on the grip core.

The grip core of the hand grip has an essentially cylindrical shape. In a simple embodiment, this can be a cylinder. The cylindrical grip casing can also be adapted to the ergonomics of the human hand so that by contrast with a purely cylindrical form, it has a diameter that varies along its longitudinal axis, for example. In this case, the grip casing can be embodied as rotationally symmetrical so that the user is able to grasp the hand grip from any angle. Alternatively, the grip casing can also be especially adapted to the ergonomics of the human hand so that a first region of the grip casing especially serves as a contact surface for the palm of the hand and a second region serves as a contact surface for the fingers.

The hand grip according to the invention is particularly suitable for use as an auxiliary hand grip for a cordless or corded hand-held power tool such as an angle grinder or a rotary hammer. A hand-held power tool equipped with a hand grip according to the invention therefore constitutes another subject of the invention.

The invention will be explained in greater detail below in conjunction with the accompanying drawings.

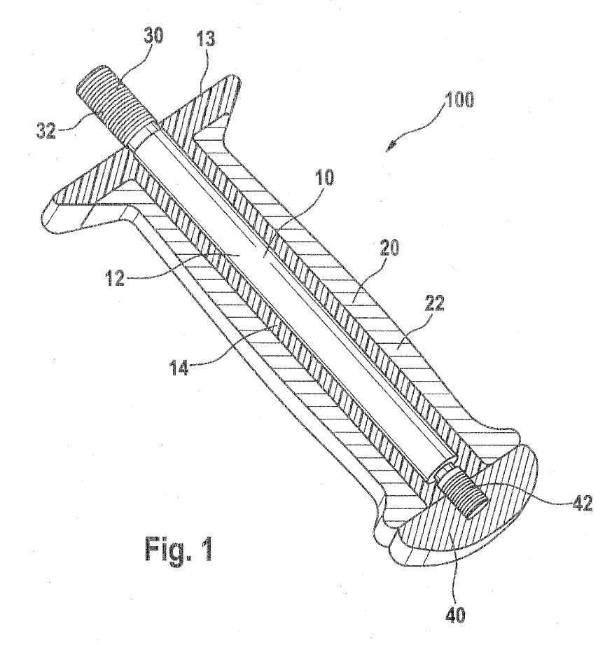

FIG. 1 shows a first embodiment of a hand grip according to the invention,

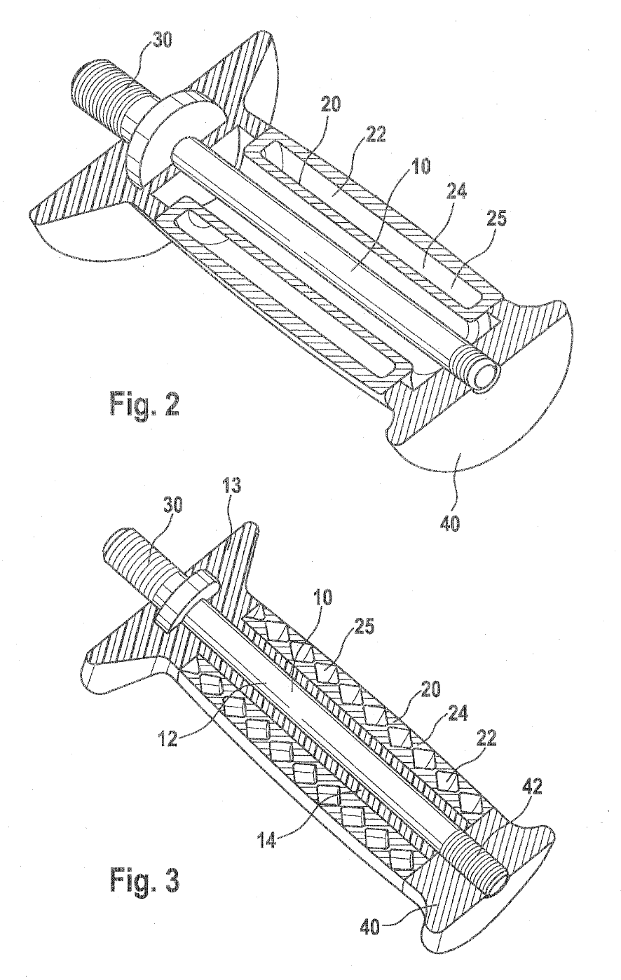

FIG. 2 shows a second embodiment of a hand grip according to the invention, with a damper cushion,

FIG. 3 shows a third embodiment of a hand grip according to the invention, with honeycomb-shaped damper cushions,

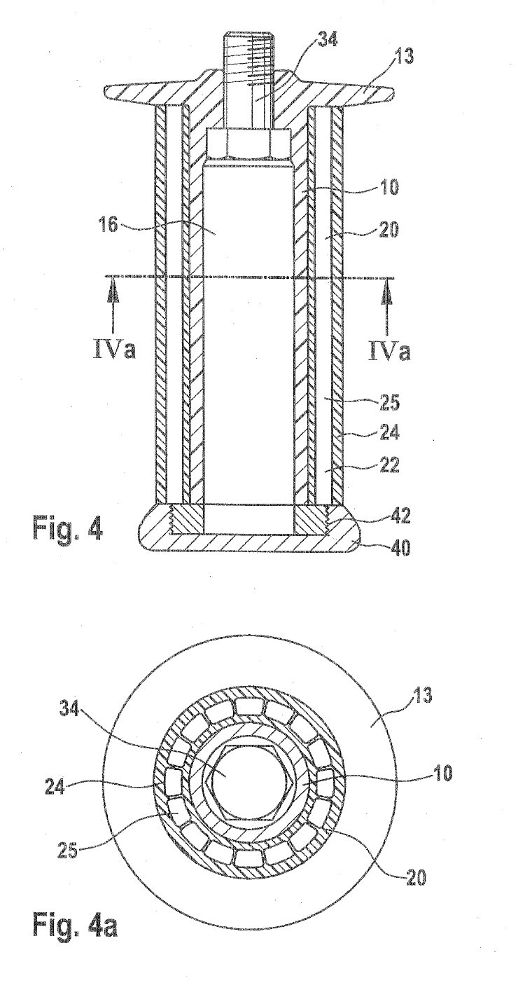

FIG. 4 shows a fourth embodiment of a hand grip according to the invention, with conduit-shaped damper cushions,

FIG. 4a shows a cross section through the embodiment according to FIG. 4,

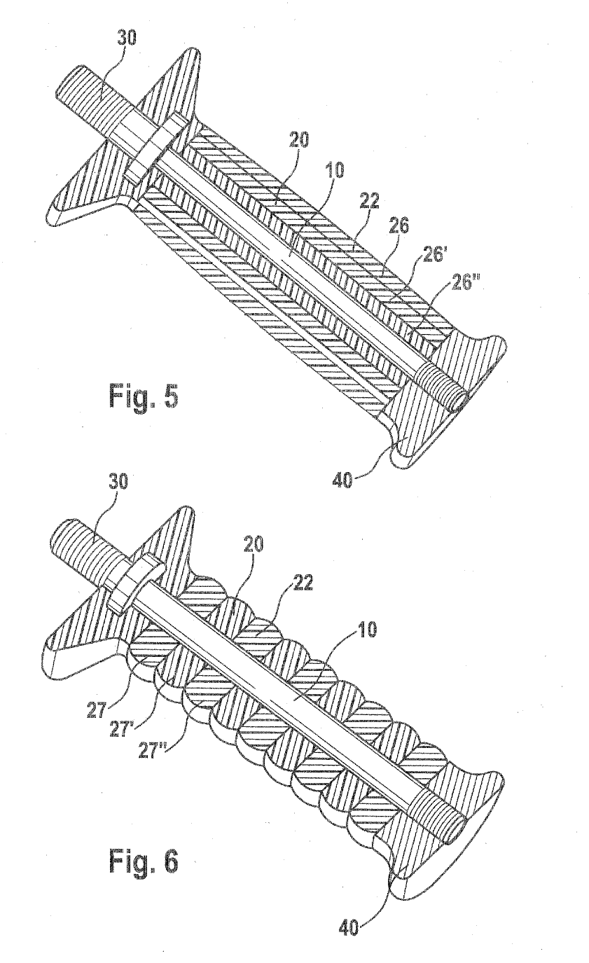

FIG. 5 shows a fifth embodiment of a hand grip according to the invention, with a grip casing that has a plurality of layers in the radial direction, and

FIG. 6 shows a sixth embodiment of a hand grip according to the invention, with a grip casing that has a plurality of layers in the axial direction.

FIG. 1 is a schematic, partially sectional depiction of a first embodiment of the hand grip 100 according to the invention, which is suitable for use as an auxiliary hand grip for a hand-held power tool such as an angle grinder. The hand grip 100 includes a grip core 10, a grip casing 20 supported on the grip core 10, and a fastening element 30. The grip casing 20 is embodied as vibration-damping in that it has one or more vibration-damping means 22, which are prestressable according to the invention.

The grip core according to FIGS. 1 and 3 is composed of two parts, a rod-shaped inner grip core 12 composed of a hard component such as steel and an outer grip core 14 that surrounds the inner grip core 12 and is likewise composed of a hard component such as a plastic. The outer grip core 14 can, for example, be composed of a thermoplastic plastic that is extrusion-coated onto the steel inner grip core 12. The outer grip core 14 is shaped so that a collar-like expansion 13 is embodied at the end of the grip core 10 oriented toward the fastening element 30. Alternatively, the grip core 10 can also be embodied of one piece, as shown for example in FIGS. 4, 5, and 6. As is also shown in FIG. 4, the grip core 10 can additionally be composed of a hollow cylinder whose cavity 16 can optionally be provided with additional vibration-damping means (not shown), for example a damper mass.

According to FIGS. 1, 2, 5, and 6, a fastening element 30 is formed onto and of one piece with the grip core 10. The inner grip core 12 in this case protrudes out from the outer grip core 14 and is provided with a thread 32 that permits the hand grip 100 to be screwed into the housing of a hand-held power tool (not shown). Other embodiments of fastening elements 30 can likewise be used, but need not be described in greater detail here since the fastening element is not essential to the present invention. FIG. 4 alternatively shows that the fastening element 30 and the grip core 10 can also be composed of two separate parts. In this case, the fastening element 30 is embodied in the form of a threaded bolt 34 that is partially accommodated in the grip core 10 and protrudes partway out from the grip core 10. The grip core 10 can, for example, be composed of a thermoplastic plastic that is extrusion-coated onto the threaded bolt 34.

In the embodiment shown in FIG. 1 among others, the grip casing 20 is mounted directly onto the grip core 10, whereas in the embodiment shown in FIG. 2, it is situated spaced apart from the grip core 10.

The grip casing 20 in the schematic depiction according to FIG. 1 is embodied as vibration-damping in that it is composed of an elastic material, in particular an elastomer material such as rubber. The grip casing 20 can also be composed of a vibration-damping foam. Alternatively, the vibration-damping means 22 can also be a net, a knitted fabric, a crocheted fabric, a meshwork, a weave, or the like, in particular composed of metal. In order to improve the feel of such a grip casing 20, the net, knitted fabric, crocheted fabric, meshwork, weave, or the like can be covered with an elastomer material, for example.

In FIG. 2, the vibration-damping grip casing 20 is embodied in the form of a damper cushion 24 that is filled with a fluid such as a gas, a liquid, or a gel. As shown in FIG. 2, the cushion 24 can be composed of only a single fluid-filled chamber 25. The cushion 24 can, however, also be subdivided into a plurality of chambers 25. The cushion 24 of the grip casing 20 shown in FIG. 3 has a plurality of chambers 25 in the form of honeycombs, whereas the chambers 25 of the grip casing 20 according to FIG. 4a are embodied in the form of longitudinally oriented conduits.

In additional embodiments according to FIGS. 5 and 6, the grip casing 20 is composed of a plurality of layers; in FIG. 5, a plurality of layers 26, 26′, 26″ of vibration-damping means 22 rest against one another in the radial direction and are thus situated concentrically around the grip core 10. The individual layers 26, 26′, 26″ can, for example, be composed of different elastomer materials or different foams with different elastic properties. According to FIG. 6, the vibration-damping means 22 are arranged in a plurality of layers resting against one another in the axial direction. The individual layers 27, 27′, 27 . . . are embodied in the form of disk-shaped rings situated around the grip core 10. An individual layer 27, 27′, 27″, . . . can, for example, be composed of a fluid-filled damper cushion or of an elastomer material such as an elastomer or a foam and the layers 27, 27′, 27″, . . . can be the same as or different from one another with regard to their damping properties.

The vibration-damping grip casing 20 can be prestressed in that a prestressing element 40 is provided for adjusting the prestressing. The prestressing element 40 can be mounted onto the grip core 10 by means of a thread 42, for example. It is thus possible to increase or decrease the prestressing of the vibration-damping grip casing 20 by means of a screwing motion of the prestressing element 40 on the grip core 10. In the embodiment shown, the prestressing element 40 is a cap, a knob, or the like, which is screwed onto the grip core 10 at the opposite end of the grip core 10 from the fastening element 30. A screwable prestressing element 40 can also be embodied as replaceable in that it can be completely unscrewed from the grip core 10 and replaced with another prestressing element 40. This is particularly advantageous if the prestressing element 40 is embodied in the form of a damper mass, thus malting it possible for a plurality of prestressing elements 40 of different masses to be kept on hand so that the user can select a suitable prestressing element 40 with a suitable damper mass depending on the specific application.

1-15. (canceled)

16. A hand grip comprising:
a grip core;
a grip casing that is supported on the grip core and has at least one vibration-damping means; and
a fastening element on an end of the grip core, wherein the vibration-damping means is prestressable.

17. The hand grip as recited in claim 16, wherein a prestressing element which adjusts the prestressing is provided.

18. The hand grip as recited in claim 17, wherein the prestressing element is embodied in the form of a damper mass.

19. The hand grip as recited in claim 16, wherein the grip core is embodied by a damper mass.

20. The hand grip as recited in claim 17, wherein the grip core is embodied by a damper mass.

21. The hand grip as recited in claim 16, wherein the vibration-damping means is an elastomer material.

22. The hand grip as recited in claim 19, wherein the vibration-damping means is an elastomer material.

23. The hand grip as recited in claim 16, wherein the vibration-damping means is a foam.

24. The hand grip as recited in claim 19, wherein the vibration-damping means is a foam.

25. The hand grip as recited in claim 16, wherein the vibration-damping means is a net, a knitted fabric, a crocheted fabric, a meshwork, or a weave, in particular composed of metal.

26. The hand grip as recited in claim 19, wherein the vibration-damping means is a net, a knitted fabric, a crocheted fabric, a meshwork, or a weave, in particular composed of metal.

27. The hand grip as recited in claim 16, wherein that the vibration-damping means is a fluid-filled cushion.

28. The hand grip as recited in claim 16, wherein the cushion has a plurality of chambers.

29. The hand grip as recited in claim 28, wherein the chambers are embodied as axial conduits.

30. The hand grip as recited in claim 28, wherein the chambers are embodied in a honeycomb shape.

31. The hand grip as recited in claim 16, wherein the vibration-damping means is composed of a plurality of layers.

32. The hand grip as recited in claim 31, wherein the vibration-damping means is composed of a plurality of layers in a radial direction of the grip casing.

33. The hand grip as recited in claim 31, wherein the vibration-damping means is composed of a plurality of layers in an axial direction of the grip casing.

34. The hand grip as recited in claim 32, wherein the vibration-damping means is composed of a plurality of layers in an axial direction of the grip casing.

35. A hand-held power tool that includes a hand grip as recited in claim 16.
